(19) United States
(12) Patent Application Publication
(10) Pub. No.: US 2013/0078942 A1
(43) Pub. Date: Mar. 28, 2013

(54) WEARABLE NETWORKED ALERT UNIT AND METHOD FOR ITS USE

(71) Applicants: Rachel Dina Owens, Brooklyn, NY (US); Henry Chanoch Turko, (US)

(72) Inventors: Rachel Dina Owens, Brooklyn, NY (US); Henry Chanoch Turko, (US)

(21) Appl. No.: 13/601,848

(22) Filed: Aug. 31, 2012

Related U.S. Application Data
(60) Provisional application No. 61/539,856, filed on Sep. 27, 2011.

(51) Int. Cl. H04W 4/22

(52) U.S. Cl. 455/404.2

(57) ABSTRACT

A wearable, networked device and system for initiating an alert signal is provided. According to one embodiment, the wearable device includes a processor and a radiofrequency transceiver, such that the device may be in wireless connection with a communications module and the global positioning system (GPS). The communications module may be embodied by a cellular phone, smartphone, satellite phone, tablet computer, etc. In another aspect, the user of the system may enter personal information, contact information and preferences into communications module using a mobile application. Upon actuation of the wearable device, a message including the user's GPS-determined location and selected information entered by the user may be sent to pre-selected contacts or a response center. Accordingly, the invention provides quick, single-handed, wireless, uninterruptible way of calling for help.

This application claims the benefit of the filing date of U.S. provisional patent application Ser. No. 61/539,856, filed on Sep. 27, 2011.

### FIELD OF THE INVENTION

The present invention relates to an alert or emergency call device that may he used to tirelessly transmit a user's location, condition and identify to an emergency response center or to another individual or location. According to one embodiment, the present invention may be configured as a ring to be worn on a user's finger, which may be in wireless communication with a communications module such as a cellular or satellite telephone. In another aspect, the communications module may be configured to solicit and store a user's personal information and preferences.

### BACKGROUND OF INVENTION

In recent times, wireless technology has empowered individuals to foe increasingly self-reliant and independent. In particular, mobile devices such as cellular telephones and smart-phones have substantially increased access to assistance in emergency situations. Wireless devices allow users to conveniently communicate with friends, family members, work associates and businesses. These devices also allow users to reach out to medical professionals and emergency services with far greater ease than was possible with landline-based telecommunication devices. However, emergency calls using such mobile phones require time-consuming dialing and word exchanges. The logistical difficulty and time delay associated with having to prepare the phone for dialing, dialing a specific number, and speaking coherently into the phone's receiver may render the phone useless in an emergency situation.

Starting in the 1990's, personal emergency call devices, such as wearable pendants that were wirelessly tethered to landline telephones, allowed users to directly contact emergency services with a push-button activation. However, because these devices utilized old landline technology, users were limited to staying within building structures to take advantage of the simplified emergency call process.

Accordingly, current emergency response technology—i.e., including mobile devices and personal emergency call devices—does not provide for a mobile, quick, single-handed, uninterruptible, discreet operation. Therefore, there is a need for an emergency response call system suitable for mobile individuals including outdoor runners, vulnerable shift workers returning to their cars in dark, empty parking lots or walking to deserted subway stations, and children or seniors who are experiencing an emergency situation, among others.

### SUMMARY OF INVENTION

In one embodiment, this invention provides a wearable device for initiating an alert signal, the device comprising a processor, an actuator in electronic communication with the processor, and a radiofrequency transceiver coupled to the processor and providing a first wireless connection to a communications module, the communications module comprising a plurality of module processors and at least one module radiofrequency transceiver, the at least one module radiofrequency transceiver providing a second wireless connection to a network, and wherein, upon actuation of the actuator, the radiofrequency transceiver sends an alert signal to said communications module via the first wireless signal connection.

In another embodiment, this invention provides a system for initiating an alert signal, the system comprising a wearable alert device comprising a first processor, an actuator in electronic communication with the first processor, and a first radiofrequency transceiver coupled to the first processor; and a communications module comprising a plurality of module processors, and at least one module radiofrequency transceiver, the at least one module radiofrequency transceiver providing a wireless connection to a network, wherein the radiofrequency transceiver of the wearable alert device provides a wireless connection between the device and the communications module, and wherein, upon actuation of the actuator, the device sends an alert signal to said communications module via a wireless connection, such that receipt of the alert signal by the communications module prompts the communications module to transmit an alert message via the network.

In another embodiment, this invention provides a method of using a system for initiating an alert signal, comprising the steps of downloading a mobile application to the communications module for use with the alert device, and, if the mobile application determines that the alert device is not in wireless communication with the communications module, using the mobile application to establish wireless communication between the alert device and the communications module, using the mobile application to save personal information to a memory of the communications module, and, if an alert situation occurs, actuating the actuator.

This invention, also provides a method of providing a system for initiating an alert signal comprising the steps of providing a wearable alert device comprising a first processor, an actuator in electronic communication with the first processor, and a first radiofrequency transceiver coupled to the first processor, and providing a mobile application for a communications module, the communications module comprising a plurality of module processors, and at least one module radiofreguency transceiver, the at least one module radiofreguency transceiver providing a wireless connection to a network, wherein the radiofrequency transceiver of the wearable alert device provides a wireless connection between the device and the communications module, wherein the software application enables the user to save personal information to a memory of the communications module, and wherein, upon actuation of the actuator, the device is sends an alert signal to said communications module via a wireless connection, such that receipt of the alert signal, by the communications module prompts the communications module to transmit an alert message via the cellular or satellite network.

This invention provides users, in one embodiment, with a quick, easy, wireless, uninterruptible way of calling for help—i.e., sending an alert that may not be aborted or canceled after it is initiated. The alert message may include precise location and time information, enabling emergency responders to reach the user quickly. The alert may be initiated with a single push of a button mounted on an alert device. Among other advantageous configurations described herein, all or part of the trigger mechanism for the device may be worn as a ring such that the wearer can activate the alert discreetly, without looking, with a single motion and without having to move the hand to a different position such as across the body, to the other hand, into a pocket or a belt etc. By pushing the button, a signal may be sent to a communications module, which in turn sends a distress signal over a cellular, satellite or other suitable network to emergency contacts or a response center, thereby providing identification, location and time information. The emergency contacts or response center in turn may summon emergency response personnel.

Another advantage of the invention is that bank employees, shopkeepers, bartenders and other vulnerable workers may use the alert device to call for help in case of a robbery or other emergency without the need to reach for a conspicuous remote button, which might further endanger them. The invention according to the following disclosure may be lightweight, easy to use, and difficult to activate accidentally.

### BRIEF DESCRIPTION OF THE DRAWINGS

FIG. 1 is a diagram illustrating of a system for initiating an emergency alert according to one embodiment the invention;

FIG. 2a is a cross-sectional schematic illustrating an emergency alert device including a disposable battery, according to one embodiment of the invention;

FIG. 2b is a cross-sectional schematic illustration of an emergency alert device including a rechargeable battery, according to one embodiment of the invention;

FIG. 2c is an external view of an emergency alert device, according to one embodiment of the invention;

FIG. 2d is a schematic illustration of a communications module in communication with an emergency alert device, according to one embodiment of the invention;

FIG. 3 is a flow chart illustrating a software application executed by the communications module, according to one embodiment of the invention;

FIG. 4a shows screen shots depicting views relating to activation of a mobile application, according to one embodiment of the invention;

FIG. 4b shows screen shots depicting views relating to use of a mobile application, according to one embodiment of the invention;

FIG. 5 is a flow chart illustrating a method of providing a system for initiating an emergency alert, according to one embodiment of the invention; and

FIG. 6 is a flow chart illustrating a method of using a system for initiating an emergency alert, according to one embodiment of the invention,

### DETAILED DESCRIPTION OF THE INVENTION

The present invention provides a system and method for initiating an emergency alert with the push of a button. In another aspect, the invention provides a method for establishing and operating a system for initiating emergency alerts, and a method for using said system.

An Alert System

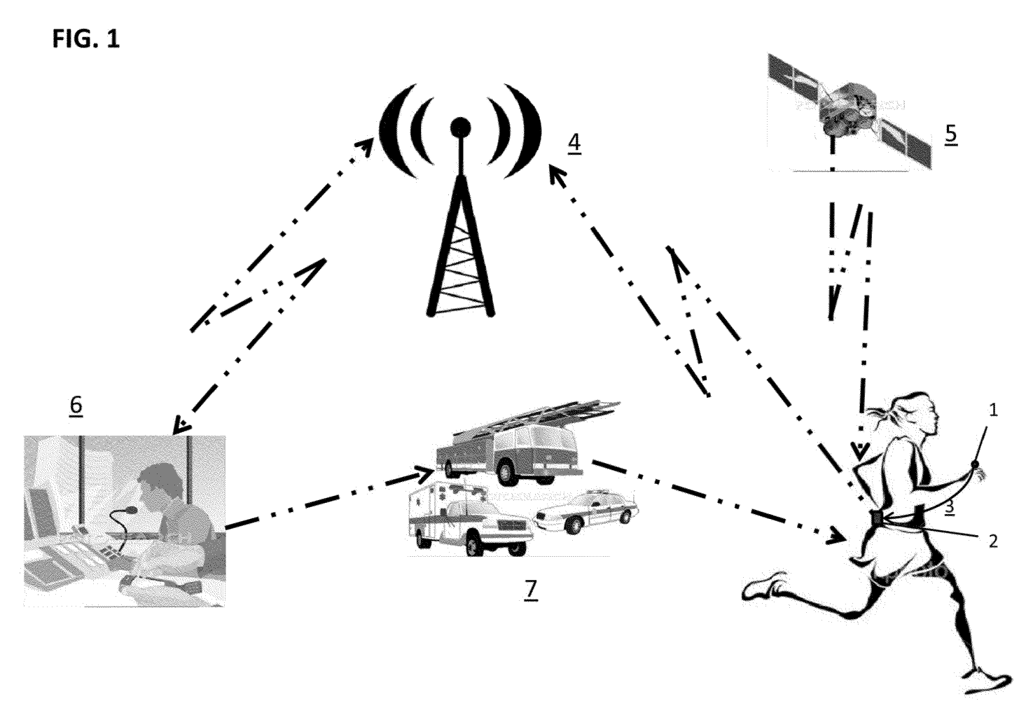

FIG. 1 is a diagram illustrating a system for initiating an emergency alert, according to one embodiment the invention. The system shown in FIG. 1 may include a wearable alert device 1 and communications module 2. During operation, the wearable alert device 1 may be in wireless communication 3 with the communications module 2. The form of this wireless communication 3 may be embodied by any suitable connection, such as, for example, radiofrequency connections including ANT™, Bluetooth©, Bluetooth Low Energy®, Radio-Frequency Identification (RFID) and ZigBee®. The communications module 2 may be in communication with a cellular network 4 as shown in FIG. 1, and/or satellite network 5, including the global positioning system (GPS). Via its network connection(s), the communications module 2 may also be in communication with an emergency response center 6 and/or state-sponsored emergency responders 7. The communications module may also be in communication with a selected individual or group of individuals.

An Alert System User Interface

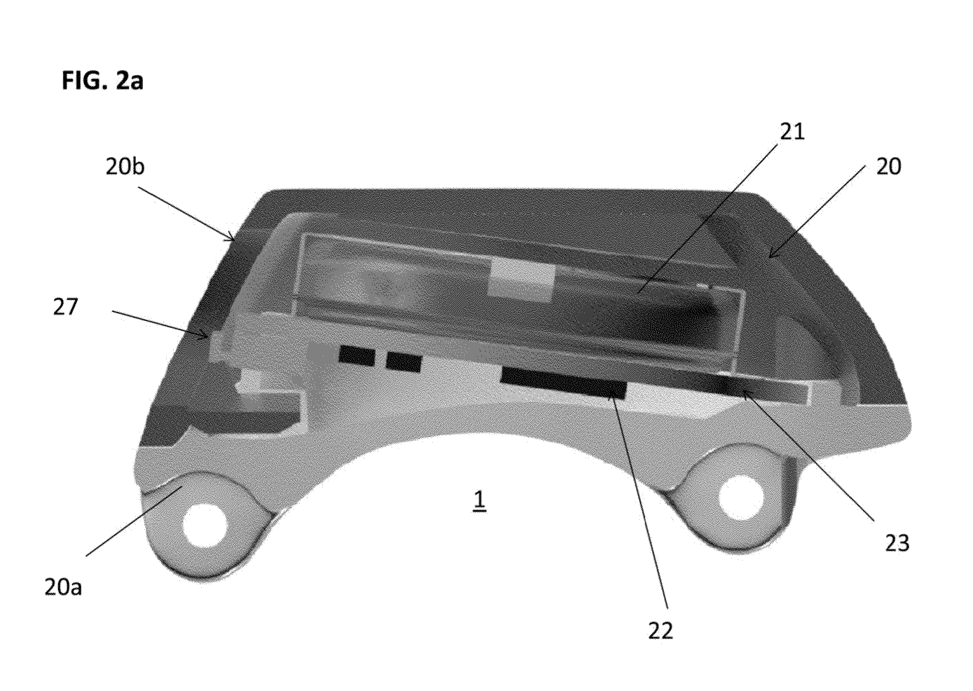

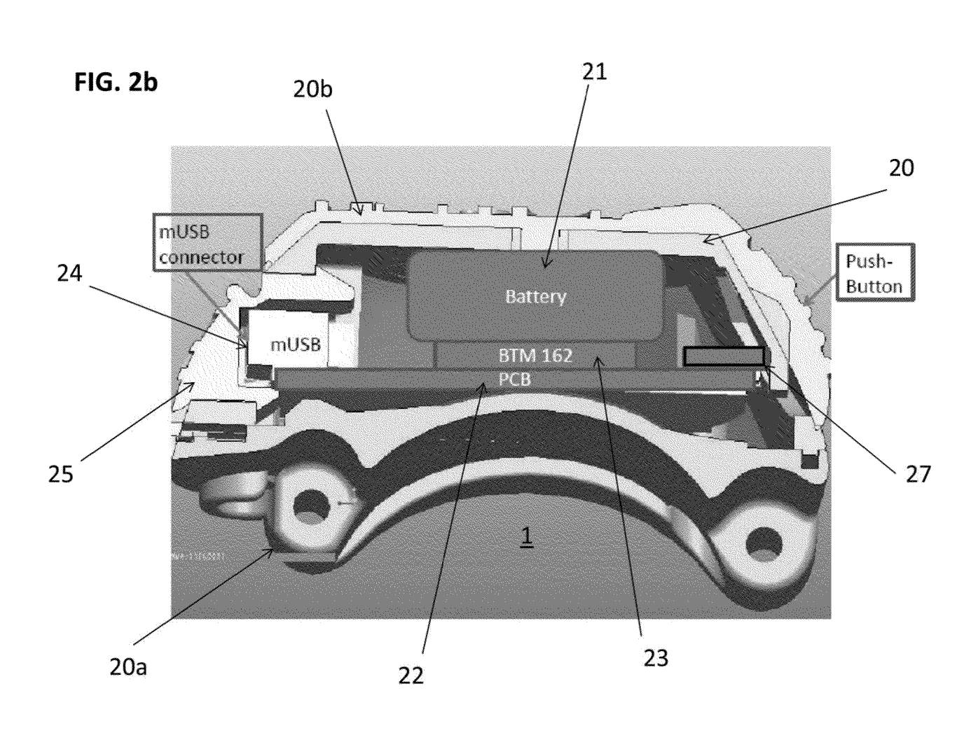

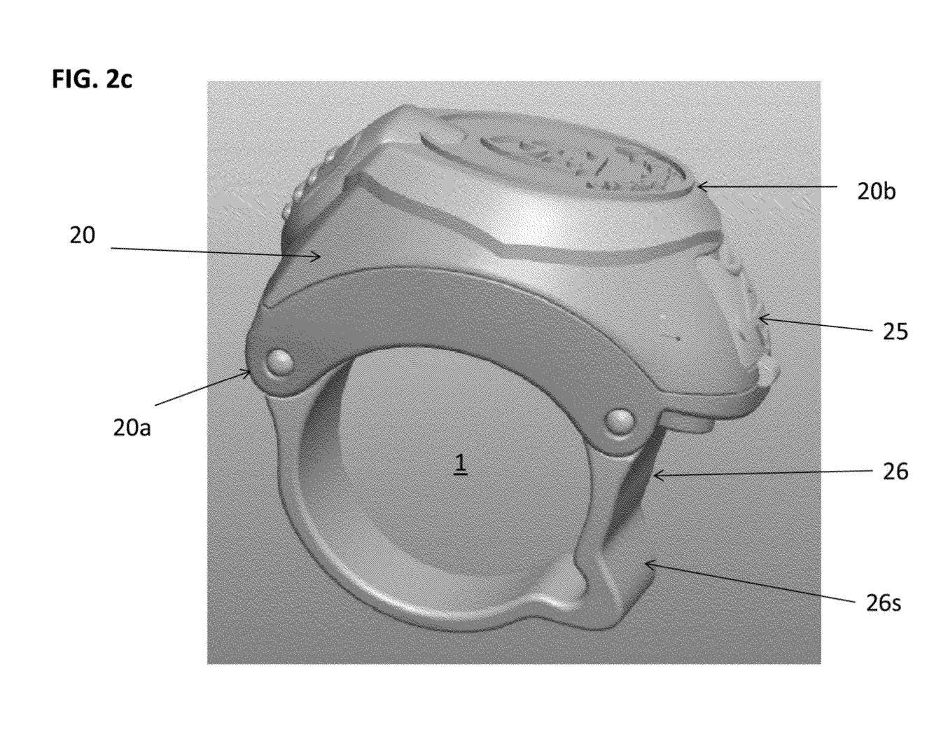

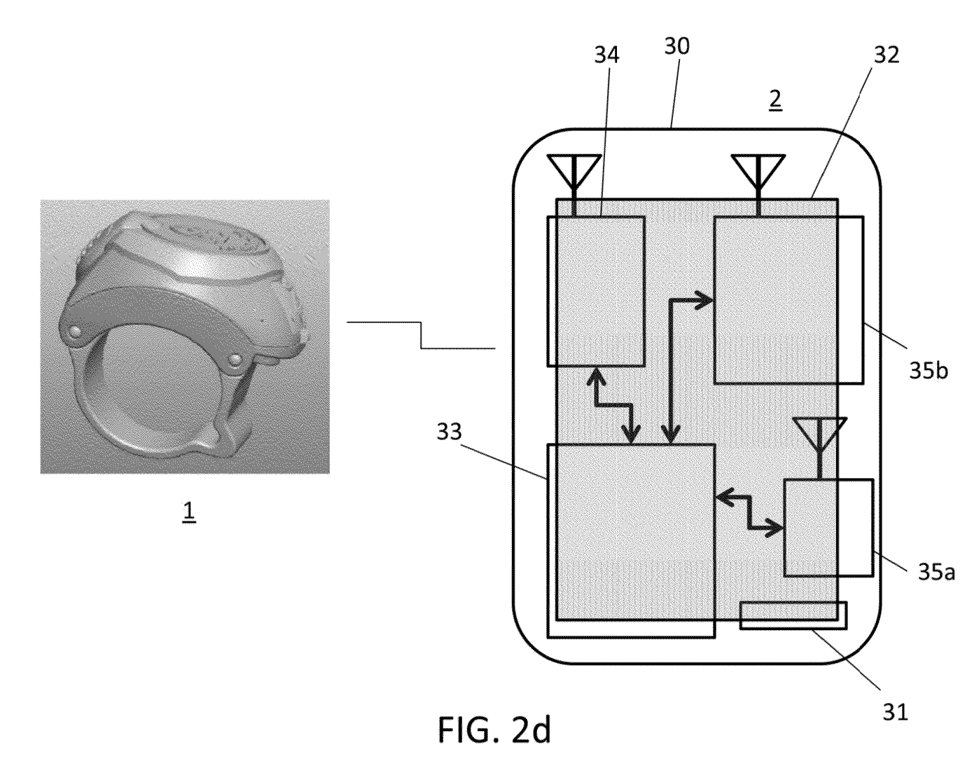

According to one embodiment, the user interface of the alert system may comprise the wearable alert device 1 and the communications module 2, which may be kept on the user's person during operation. FIGS. 2a through 2c depict embodiments of the wearable alert device 1, wherein identical numerals represent corresponding structures common to the pictured embodiments. The communications module 2 and the alert device 1, as shown in FIG. 2d, according to one embodiment, may be used in combination to provide a long-range wireless connection to the alert device 1, such as a connection to a cellular network, among other available networks.

FIG. 2a is a cross-sectional schematic illustrating an emergency alert device including a disposable battery, according to one embodiment of the invention. The wearable alert device 1 may include a housing 20 that encloses a power source 21, such as a disposable battery, and a processor 22 configured for wireless, radiofrequency communication via, for example, Bluetooth© and ANT™ by inclusion of a radiofrequency transceiver 23. According to one embodiment, the processor 22 may comprise a printed circuit board assembly incorporating surface-mount technology. The housing may include a shell 20a to which the processor 22 is mounted, as well as an overmould 20b.

FIG. 2b is a cross-sectional schematic illustration of an emergency alert device according to one embodiment of the invention. As shown in FIG. 2b, the power source 21 may be a rechargeable battery, and the housing 20 may comprise a power input or charging port, such as a serial bus connection or USB port 24. Such a port may also be used to transfer data, and when not in use, may be covered by a port cover 25. The overmould 20b may cover an actuator 27, such as a push-button or toggle switch, in electronic communication with the processor 22, the actuation of which initiates transmission of an alert message via the communications module 2.

FIG. 2c is an external view of an emergency alert device, according to one embodiment of the invention. As seen in FIG. 2c, a band 26 may foe attached to the housing 20, such that the alert device 1 may be worn, for example, securely on the finger of a user. According to one embodiment, the band may be flexible, and may be interchangeable with differently sized or conformed bands such that individuals of varying shapes and sizes may utilize the device with ease and comfort. In one embodiment, the band may include a stretchable accordion section 26s, which further increases the adjustability and wearability of the band.

The housing 20 and band 26 may be constructed from any suitable material, such as, for example, plastic materials. In particular, the band 26 and overmould 20b may include silicone rubber, or any other material that one of ordinary skill in the art deems appropriate. In an alternative embodiment, the alert device 1 may foe configured to be worn as part of a glove, wristband, armband, anklet, brooch or shoulder pad.

According to an embodiment, the alert device 1 may exist in any one of a number of different power states depending on which of its components are active. Those available power states comprise (1) a fail-safe recovery state, when the USB is on; (2) a connectable-discoverable state when the USB is off, but the radiofrequency connection is active; (3) a connectable-discoverable-flashable state when the USB and radiofrequency connections are both on; (4) a connected state when the radiofrequency connection is active, but the USB is off; and (5) a low power mode when the battery is powering the device 1, but no components are active.

FIG. 2d is a schematic illustrating a communications module in communication with an alert device 1 according to another embodiment of the invention. As seen from FIG. 2d, according to one embodiment, the communications module 2 may comprise a mobile or satellite phone, or satellite tracking/communications device. In another mobile embodiment, the communications module 2 may comprise a portable networked computing device, such as a laptop or tablet computer, or a personal digital assistant. In another embodiment that can, for example, be used in a building such as a bank or retail location, the communications module 2 may be a fixed, networked computer. A fixed, embodiment of the communications module 2 may also include a landline connection to a telephone network.

According to one embodiment, the communications 2 module may include a housing 30, a power source 31, such as a rechargeable battery, an input mechanism 32, such as a keypad or touch screen, a computer processor 33 with a memory, a GPS receiver 34 and mechanisms for radiofrequency connections with the alert device 1 and a cellular or satellite network, including at least one alert device radiofrequency transceiver 35a and at least one cellular or satellite radiofrequency transceiver 35b. According to an alternative embodiment, the communications module 2 may be joined to the alert device 1, such that the two components share a single housing, or such that the two components are detachably fixed to one another. In such an embodiment, wherein the communications module 2 and the alert device 1 are joined, they may communicate via a wired or a wireless connection.

According to one embodiment, the communications module 2 may also be configured to send messages by SMS, MMS and/or e-mail. It may be configured to tirelessly exchange data over a local area computer network using Wi-Fi™ technology. According to one embodiment the housing 30 may include a power input, such as a serial bus connection, which may also be used to transmit data. By virtue of the GPS receiver 34 and processor 33, the module may be configured to maintain a user's updated location information, which the module 2 may transmit upon actuation of the alert device 1. The memory of the communications module 2 may also be configured to store one or more users' personal and medical information. Any information saved to the communications module 2 may be accessed by the user through the user interface or a USB connection.

A Wearable Device Software Application

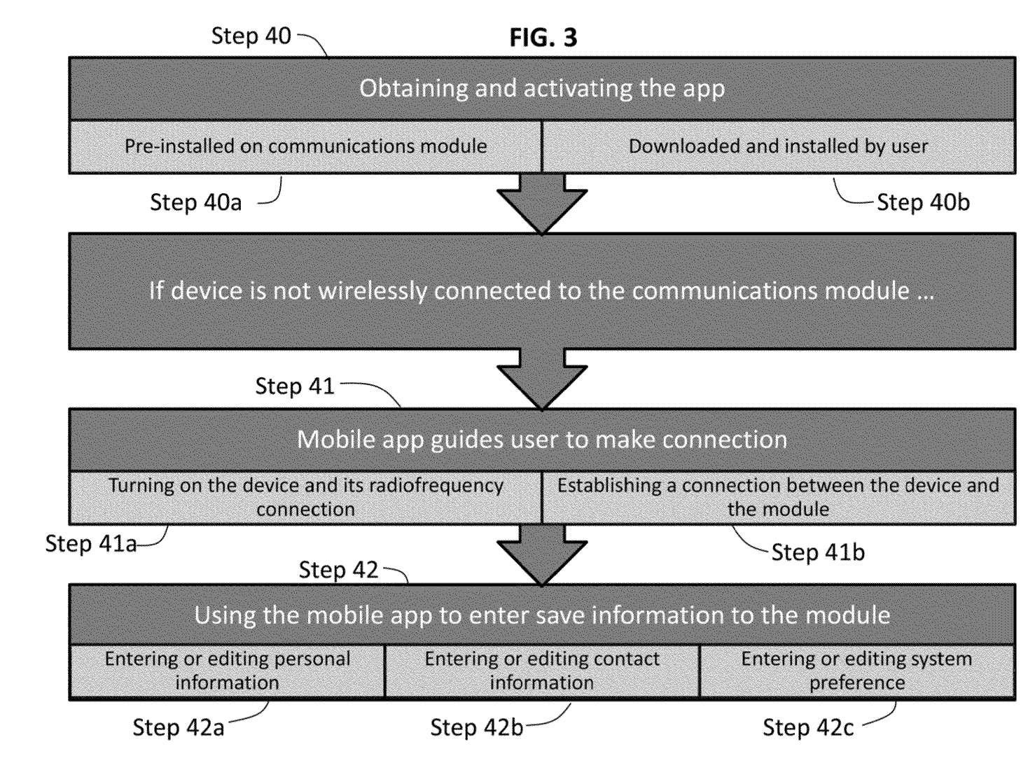

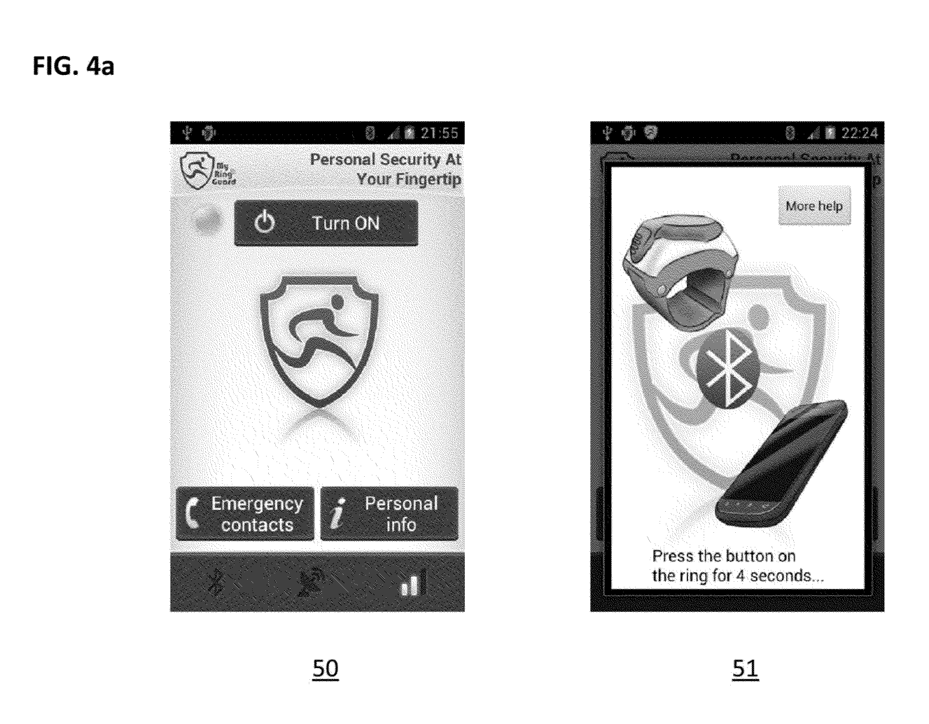

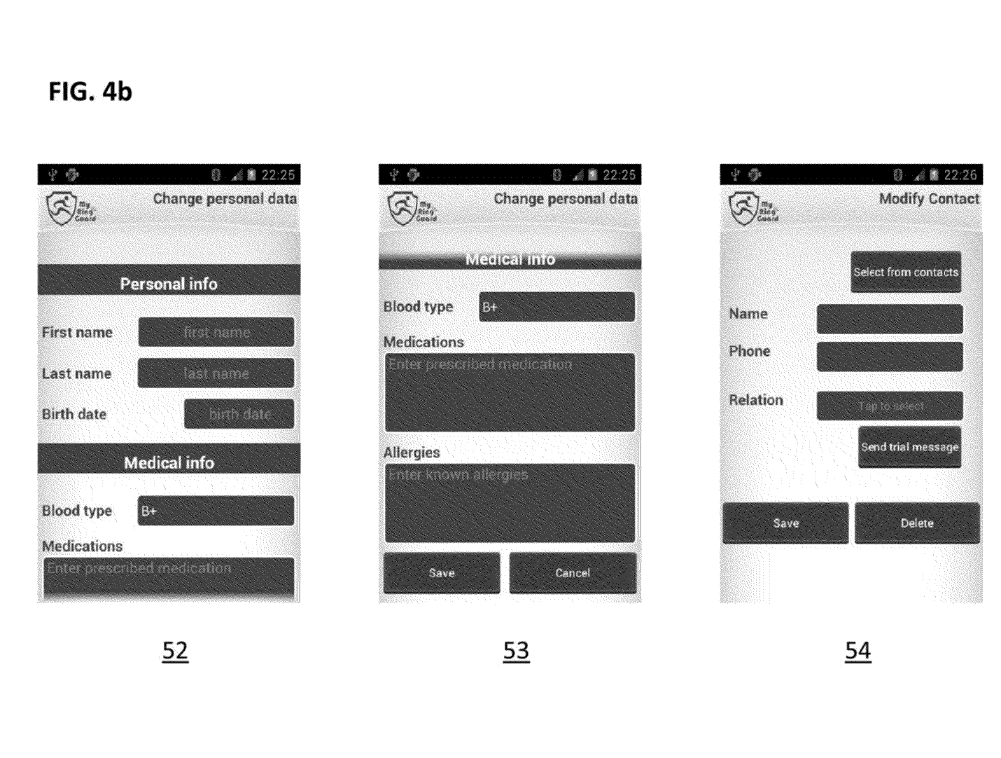

FIG. 3 is a flow chart illustrating the operation of a software application (hereinafter, the “app”) according to one embodiment, which may be executed by the communications module 2. FIGS. 4a and 4b depict exemplary user interface screens that may accompany the steps shown in FIG. 3. According to one embodiment of the invention, the app may enable the user to enter and update information and preferences relevant to functioning of the alert device 1 and system. For example, a user may save identification and other relevant information with the app's user interface. According to an embodiment of the invention, the app may also be used, to mediate radiofrequency connectivity between the alert device 1 and the communications module 2, for example, by providing an interface for ascertaining the power and connectivity status of the device.

In one embodiment of the invention, as shown in FIG. 3, the app is obtained and activated by the user Step 40. The app may be obtained by being pre-installed on the communications module Step 40a, or it may be downloaded or uploaded and/or installed by a user Step 40b. Once the app is installed on the communications module and turned on, it may operate by execution of a software algorithm to determine whether the alert device is in communication with the communications module. The user interface may appear as shown in FIG. 4a, 50. If the ring is not connected, the app may guide the user through connection steps Step 41 such as turning on the device and its radiofrequency connection Step 41a—i.e., Bluetooth® or ANT™—and establishing a connection between the alert device and the communications module Step 41b. The user interface may then appear as shown, in FIG. 4a, 51. The app may also interact with the GPS receiver of the communications module to begin tracking the location of the communications module. When GPS tracking is activated, the app may be in listening mode, whereby it may cause the communications module to monitor the power level of the alert device 1 and await actuation of the push-button alert.

In another aspect of the invention, the user may also employ the app user interface to enter, edit and save information to the memory of the communications module Step 42. Saving information may include entering or editing personal information Step 42a such as names, birth dates, home and work addresses, employer information, medical insurance, preexisting conditions, medications, allergies, a pre-recorded alert message, blood type, etc. According to one embodiment, the user interface may then appear as shown, in FIG. 4b, 52 and 53. The app also may also provide an interface for entering and editing contact information Step 42b for next of kin, or other contacts such as friends or doctors, and their identification information and phone numbers. According to yet another embodiment, the user interface may then appear as shown in FIG. 4b, 54. The identification information of contacts may include names, relation to the user, residence, etc. The user may also enter preferences Step 42c governing the use of the app and the alert device. For example, a scheduler may be used to automatically activate the alert device and prompt the communications module to run in listening mode during selected activity times, such as when the user is planning to run or travel alone. The user may also indicate using the app which information is appropriate for sending upon actuation, of the alert device.

A Method of Providing an Emergency Alert System

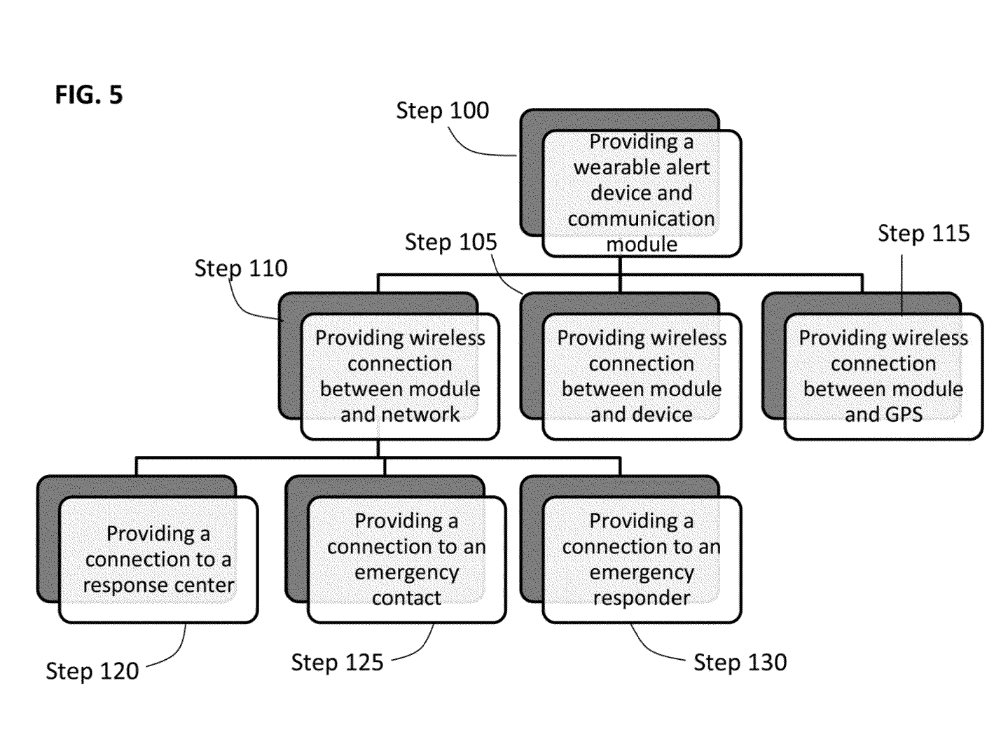

FIG. 5 is a flow chart illustrating a method of providing an operational emergency alert system according to one embodiment of the invention. According to an embodiment of the invention, this method may include the steps of providing a wearable alert device and a communication module Step 100, such that the alert device and communication module are in wireless communication with each other Step 105, and the communication module is in wireless communication with a cellular, satellite, or other applicable communications network Step 110, as well as a GPS satellite network Step 115.

In another aspect, the method may include providing for a connection via the wireless network between the communications module and at least one of a response center Step 120, emergency contact Step 125 or state-sponsored emergency responder Step 130, or other selected individual or entity. According to one embodiment the response center may be embodied by a privately- or publicly-held company organized to accept and interpret emergency communications, such as alerts provided by the alert device, and to notify relevant emergency responders. Emergency contacts may include any individuals identified by information entered into the communications module, such as, for example next of kin or a primary care physician. State-sponsored emergency responders may include any emergency responders reachable by dialing 911, including the police, firefighters, paramedics or emergency medical technicians. Bearing important information regarding the condition and whereabouts of the user, emergency re spenders may thus be enabled to provide optimal, emergency care to the user, and/or take any other appropriate action.

Method of Using an Emergency Alert System

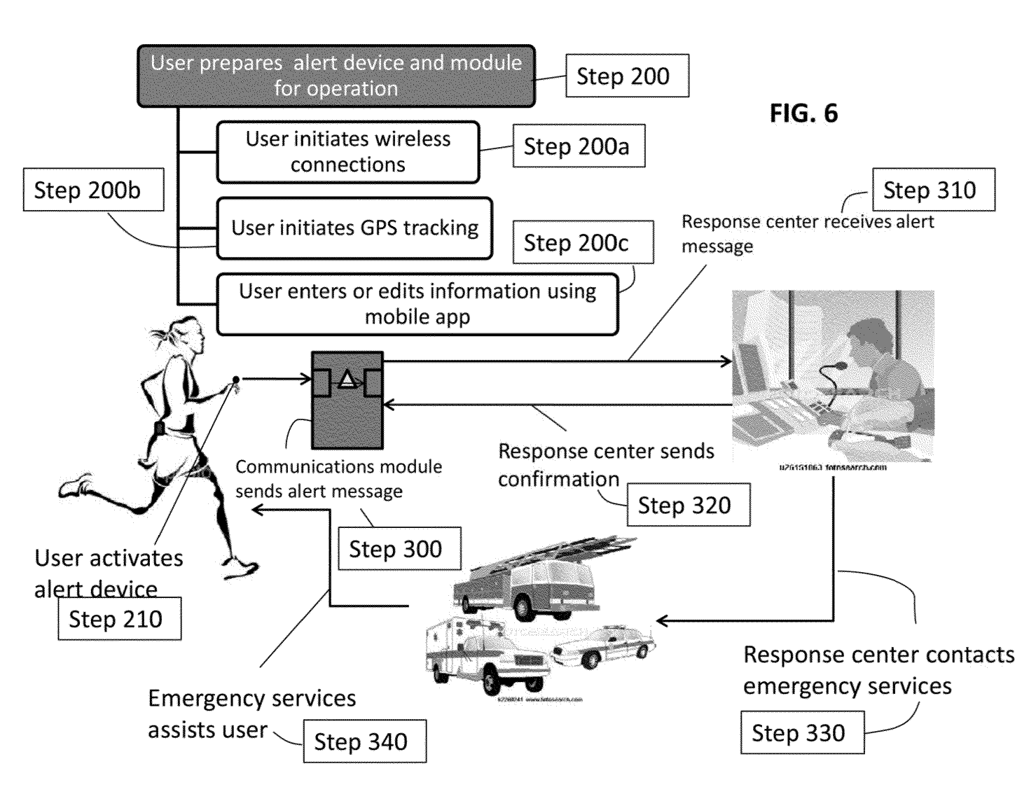

FIG. 6 is a flow chart illustrating a method of using an emergency alert system according to another embodiment of the invention. Once a user is provided with a communications module configured with the appropriate wireless connections, the user may download the proprietary mobile app as shown in FIG. 3 if the app is not already installed. After the user acquires the alert device and communications module, he or she may prepare them for operation Step 200. For example, the preparation step 200 may include initiating the wireless connection between the communications module and alert device by means of the app Step 200a, ensuring that the GPS receiver is tracking the location of the communications module using the app Step 200b, and entering or editing identification or other relevant information with the app Step 200c.

In an emergency situation, the user may activate the alert device 1 by depressing the actuator Step 210. Subsequently, the actuator 25 may prompt the communications module 2 to send an alert message Step 300 to the party or parties indicated by information entered via the app. The alert message may be an SMS, e-mail or recorded voice message or other appropriate message format, and may be accompanied by or include the user's identification and GPS-determined location information. In one embodiment of the invention, for example, if an emergency response center is one of the parties, it may receive the alert message Step 310 and send a confirmation of receipt message Step 320 to the communications module 2. The response center may also contact state-sponsored emergency professionals Step 330, who may, in turn, meet and/or assist the user Step 340.

Accordingly, there has been shown and described a wearable, networked alert device, a method for its use, and a system for implementing its use. The device, systems and methods for their use are not limited to any particular hardware or software configuration. The many variations, modifications and alternative applications of the invention that would be apparent to those skilled in the art, and that do not depart from the scope of the invention are deemed to be covered by the invention.

We claim:

1. A wearable device for initiating an alert signal, the device comprising:
a processor,
an actuator in electronic communication with the processor, and
a radiofrequency transceiver coupled to the device processor and providing a first wireless connection to a communications module, the communications module comprising a plurality of module processors and at least one module radiofrequency transceiver, the at least one module radiofrequency transceiver providing a second wireless connection to a network, and
wherein, upon actuation of the actuator, the radiofrequency transceiver sends an alert signal to said communications module via the first wireless signal connection.

2. A device according to claim 1, further comprising a housing and an overmould covering the actuator, wherein the housing includes a shell to which the device processor is mounted.

3. A device according to claim 1, further comprising a first band for securing the device to a user's body.

4. A device according to claim 1, wherein the first wireless connection to the communications module is a radiofrequency connection using at least one of Bluetooth®, ANT™, or Bluetooth Low Energy® technology.

5. A device according to claim 1, wherein the housing comprises a serial bus connection.

6. A device according to claim 3, wherein said first band is interchangeable with at least a second band, the second band having a different size than the first band.

7. A device according to claim 3, wherein said first band for securing the device to a user's body comprises silicone rubber.

8. A device according to claim 1, wherein at least one module radiofrequency transceiver comprises a GPS receiver.

9. A system for initiating an alert signal, the system comprising:
a wearable alert device comprising
a first processor,
an actuator in electronic communication with the first processor, and
a first radiofrequency transceiver coupled to the first processor, and
a communications module comprising
a plurality of module processors, and
at least one module radiofreguency transceiver, the at least one module radiofreguency transceiver providing a wireless connection to a network,
wherein the radiofreguency transceiver of the wearable alert device provides a wireless connection between the device and the communications module, and
wherein, upon actuation of the actuator, the device sends an alert signal to said communications module via a wireless connection, such that receipt of the alert signal by the communications module prompts the communications module to transmit an alert message via the network,

10. A system according to claim 9f wherein the communications module is one of a cellular phone, smartphone, satellite phone or personal digital assistant.

11. A system according to claim 9, wherein at least one module radiofrequency transceiver comprises a GPS receiver.

12. A system according to claim 9, further comprising a stretchable band for securing the device to a user's body,

13. A system according to claim 9, wherein said wireless connection to the communications module and said wireless connection to the network are radiofrequency connections using at least one of Bluetooth®, ANT™, or Bluetooth Low Energy© technology.

14. A system according to claim 9, wherein said communications module is executes a software application for soliciting and storing personal information, the personal information including a user's birth date, next of kin, pre-existing conditions and at least one telephone number.

15. A method of using a system according to claim 9, comprising the steps of:
downloading a software application to the communications module for use with the alert device, and, if the mobile application determines that the alert device is not in wireless communication with the communications module,
using the software application to establish wireless communication between the alert device and the communications module,
using the software application to save personal information to a memory of the communications module, and, if an alert situation occurs, actuating the actuator using a single motion.

16. A method according to claim 15, further comprising the step of securing the alert device to a user's body.

17. A method according to claim 15, wherein the alert message includes the user's personal information and GPS-determined location.

18. A method of providing a system for initiating an alert signal comprising she steps of:
providing a wearable alert device comprising
a first processor,
an actuator in electronic communication with the first processor, and
a first radiofreguency transceiver coupled to the first processor, and
providing a software application for a communications module,
the communications module comprising
a plurality of module processors, and
at least one module radiofrequency transceiver, the at least one module radiofrequency transceiver providing a wireless connection to a cellular network,
wherein the radiofrequency transceiver of the wearable alert device provides a wireless connection between the device and the communications module,
wherein the software application enables the user to save personal information to a memory of the communications module, and
wherein, upon actuation of the actuator, the device sends an alert signal to said communications module via a wireless connection, such that receipt of the alert signal by the communications module prompts the communications module to transmit an alert message via the network.

19. A method according to claim 18, wherein the alert message includes the user's personal information and GPS-determined location,

20. A method according to claim 19, further comprising the step of providing a response center capable of receiving said alert message and forwarding the user's personal information and GPS-determined location to emergency responders.

21. A device according to claim 1, wherein after actuation of the actuator, the alert signal is uninterruptable.
